(19) United States
(12) Patent Application Publication
(10) Pub. No.: US 2025/0162385 A1
(43) Pub. Date: May 22, 2025

(54) Interior Camera Active HVAC Modulation

(71) Applicant: Panasonic Automotive Systems Company of America, Division of Panasonic Corporation of North America, PEACHTREE CITY, GA (US)

(72) Inventor: JOSEPH THOMAS PERRY, OXFORD, MI (US)

(21) Appl. No.: 18/938,735

(22) Filed: Nov. 6, 2024

Related U.S. Application Data
(60) Provisional application No. 63/599,767, filed on Nov. 16, 2023.

(51) Int. Cl. B60H 1/34; B60H 1/00

(52) U.S. Cl. CPC B60H 1/3421; B60H 1/00871; B60H 2001/3471

(57) ABSTRACT

An air ventilation arrangement for a motor vehicle includes means for detecting a location of a human hand in a space in proximity to an air vent of the motor vehicle. An actuator moves baffles of the air vent to thereby change a direction of air flow out of the air vent. An electronic processor is communicatively coupled to the detecting means and to the actuator. The electronic processor controls the actuator to move the baffles such that the air flows out of the air vent in a direction toward the detected location of the human hand.

### CROSS-REFERENCED TO RELATED APPLICATIONS

This application claims benefit of U.S. Provisional Application No. 63/599,767, filed on Nov. 16, 2023, the disclosure of which is hereby incorporated by reference in its entirety for all purposes.

### BACKGROUND OF THE INVENTION

### 1. Field of the Invention

The present invention relates to automotive heat, ventilation, air conditioning (HVAC) systems.

### 2. Description of the Related Art

Different users can have unique challenges in manually controlling an automotive HVAC system. For example, a user may have a small stature which makes adjustments difficult due to limited reach. Individuals with disabilities may have limited fine motor skills with which to control the HVAC system. Current vehicle air vents are either actuated by hand which requires fine motor control that not all users may have, or through displays which pose the same input problems. Adjusting also requires moving attention away from the road to find the control surfaces, which poses a safety concern in particular for display based methods as they have no tactility.

In vehicles such as Teslas, the venting is controlled via making selections on the display screen and dragging to aim the ventilation. This forces the user to make fine adjustments in a small area to articulate, and requires the user to look at the display screen.

The user may adjust the vents via analog articulation, such as by angling the vent assembly and moving small sliders. Not all users are able to do this, however, due to having fine motor function issues. Using the analog method also requires trial and error on the user's part in order to assess whether the air is flowing to the desired position.

### SUMMARY OF THE INVENTION

The invention may utilize an interior camera to enable electronically actuated air vents to follow the hand position of the passenger to redirect the vents. The vent may follow the hand through the full range of motion that a typical vent can support, both in horizontal and vertical directions. Depending on the accuracy of the detection, different hand gestures may signal to raise or lower HVAC temperature or speed. The user's interaction with and/or feedback from the ventilation system may be tactile through feeling the airflow with his hand, thereby eliminating the need to remove his gaze from the road in order to adjust the ventilation system via pushbuttons, dials and/or a touchscreen.

The driver/passenger may simply hold their hand in front of the vent area, and the actuation may follow the hand position to the desired location. The inventive system may average out the position of the hand in space so that it still functions well even when the user has slight hand/arm tremors.

In one embodiment, a camera-based system may be mostly vehicle agnostic. Hand position and gestures may be detected by camera-based systems or by using electric field detection, for example. Devices that can perform electric field detection on a human hand may include capacitance sensors and gas discharge visualization (GDV) cameras.

The invention comprises, in one form thereof, an air ventilation arrangement for a motor vehicle, including means for detecting a location of a human hand in a space in proximity to an air vent of the motor vehicle. An actuator moves baffles of the air vent to thereby change a direction of air flow out of the air vent. An electronic processor is communicatively coupled to the detecting means and to the actuator. The electronic processor controls the actuator to move the baffles such that the air flows out of the air vent in a direction toward the detected location of the human hand.

The invention comprises, in another form thereof, a method of providing air ventilation in a motor vehicle, including automatically detecting a location of a human hand in a space adjacent to an air vent of the motor vehicle. Baffles of the air vent are automatically moved to thereby direct an air flow out of the air vent toward the detected location of the human hand.

The invention comprises, in yet another form thereof, an air ventilation arrangement for a motor vehicle including an air vent. A camera captures images of a human hand in a space in proximity to the air vent. An actuator moves baffles of the air vent to thereby change a direction of air flow out of the air vent. An electronic processor is communicatively coupled to the camera and to the actuator. The electronic processor analyses the images captured by the camera to thereby determine a location of the human hand in three-dimensional space. The electronic processor controls the actuator to move the baffles such that the air flows out of the air vent in a direction toward the determined location of the human hand.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of an active HVAC modulation arrangement of the present invention.

FIG. 2 is a schematic view of electrically actuated baffling in a centered orientation within an air vent.

FIG. 3 is a schematic view of the electrically actuated baffling of FIG. 2 in an angled orientation in order to direct air flow toward the hand position.

FIG. 4 is a flow chart of one embodiment of a method of the present invention for providing air ventilation in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

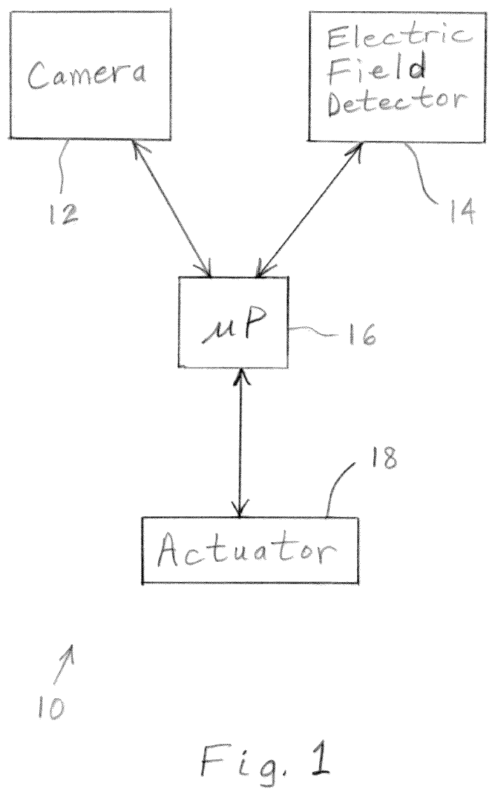

FIG. 1 illustrates one embodiment of an active HVAC modulation arrangement 10 of the present invention for installation in a motor vehicle. Arrangement 10 includes a camera 12, an electric field detector 14, an electronic processor 16, and an actuator 18.

During use, camera 12 may capture images of a user's hand, and processor 16 may analyze those captured images to thereby determine a location and position of the user's hand. In addition, or alternatively, electric field detector 14 may collect data about an electric field associated with the user's hand. Processor 16 may analyze those data to thereby determine a location and position of the user's hand. Electric field detector 14 may be in the form of a capacitance sensor or a gas discharge visualization (GDV) camera, for example. Having determined the location and position of the user's hand, processor 14 may control actuator 18 to move, shift and/or adjust baffles of the vehicle's HVAC vents such that air flow is directed at the current position of the user's hand in three-dimensional space.

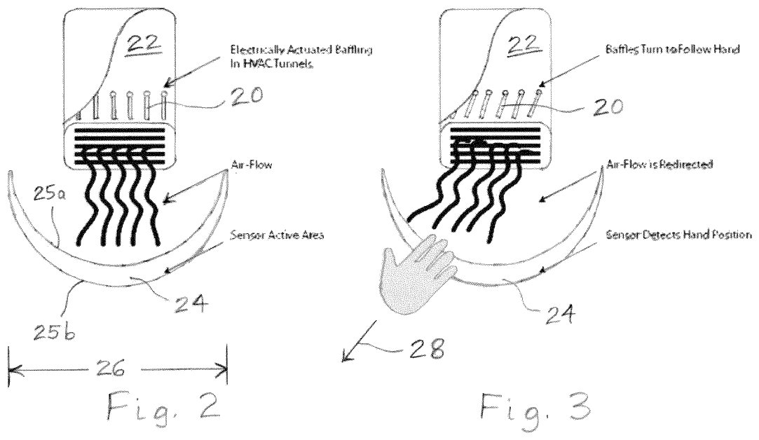

FIG. 2 illustrates electrically actuated baffling 20 in a centered orientation within an HVAC tunnel 22 of an air vent to blow air into a passenger compartment of a motor vehicle. The position of the user's hand may be detected by camera 12 or electric field detector 14 while the hand is at least partially within a three-dimensional sensor active space 24 that is adjacent to, and in proximity to, the air vent. In one embodiment, space 24 may have a height in a direction into the page of FIG. 2 of approximately between four inches and eighteen inches, and may have a same shape along this height. Space 24 may have a crescent shape, as shown in FIGS. 2-3, when viewed in a vertical direction into the page of FIGS. 2-3. The crescent shape may be defined by two opposing arcuate boundaries 25a-b. In one embodiment, space 24 may have a width 26 of approximately between one foot and three feet.

FIG. 3 illustrates electrically actuated baffling 20 of FIG. 2 in an angled orientation in order to direct air flow toward the detected position of the user's hand. Baffling 20 may be moved from the orientation of FIG. 2 to the orientation of FIG. 3 by actuator 18 under the control of processor 16.

Although only baffling 20 to change the horizontal direction of the air flow is shown in FIGS. 2-3, it is to be understood that baffling to change the vertical direction of the air flow is also re-oriented by actuator 18. Thus, actuator 18 can move baffling 20 to change both the horizontal and vertical direction of the air flow, and to direct the air flow to wherever the hand is within three-dimensional space 24.

The air flow is not caused by actuator 18 to follow the hand outside of space 24. Accordingly, after the user moves his hand out of space 24, the air flow is directed to whatever point in space 24 that was last occupied by the user's hand. Once the user has moved his hand to a point in space 24 to which he would like the air flow to be directed, and he has tactilely verified that the desired air flow direction has been achieved, he may back his hand out of space 24 in a generally radial direction, such as the direction indicated by arrow 28, so that the air flow continues to blow in the desired direction after his hand has exited space 24.

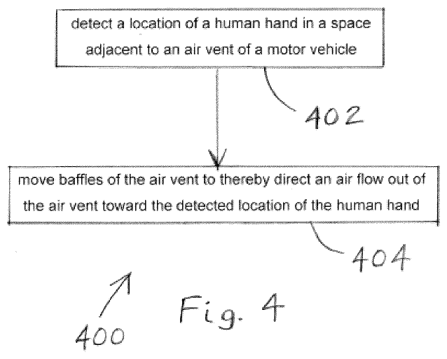

FIG. 4 is a flow chart of one embodiment of a method 400 of the present invention for providing air ventilation in a motor vehicle. In a first step 402, a location of a human hand in a space adjacent to an air vent of the motor vehicle is detected. For example, camera 12 may capture images of a user's hand, and processor 16 may analyze those captured images to thereby determine a location and position of the user's hand.

In a final step 404, baffles of the air vent are moved to thereby direct an air flow out of the air vent toward the detected location of the human hand. For example, processor 14 may control actuator 18 to move, shift and/or adjust baffles of the vehicle's HVAC vents such that air flow is directed at the current position of the user's hand in three-dimensional space.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An air ventilation arrangement for a motor vehicle including an air vent, the arrangement comprising:
means for detecting a location of a human hand in a space in proximity to the air vent;
an actuator configured to move baffles of the air vent to thereby change a direction of air flow out of the air vent; and
an electronic processor communicatively coupled to the detecting means and to the actuator, the electronic processor being configured to control the actuator to move the baffles such that the air flows out of the air vent in a direction toward the detected location of the human hand.

2. The arrangement of claim 1 wherein the detecting means comprises a camera.

3. The arrangement of claim 1 wherein the detecting means comprises an electric field detector.

4. The arrangement of claim 1 wherein the space is enclosed by imaginary boundaries.

5. The arrangement of claim 4 wherein the space is crescent-shaped when viewed in a vertical direction.

6. The arrangement of claim 4 wherein the electronic processor is configured to not control the actuator to move the baffles when the human hand is outside the boundaries.

7. The arrangement of claim 4 wherein the space has a height of approximately between three inches and eighteen inches, and a width of approximately between one foot and three feet.

8. A method of providing air ventilation in a motor vehicle, the method comprising the computer-implemented steps of:
detecting a location of a human hand in a space adjacent to an air vent of the motor vehicle; and
move baffles of the air vent to thereby direct an air flow out of the air vent toward the detected location of the human hand.

9. The method of claim 8 wherein the detecting step is performed by a camera.

10. The method of claim 8 wherein the detecting step is performed by an electric field detector.

11. The method of claim 8 wherein the space is enclosed by imaginary boundaries.

12. The method of claim 11 wherein the space is crescent-shaped when viewed in a vertical direction.

13. The method of claim 11 wherein the baffles are not moved when the human hand is outside the boundaries.

14. The method of claim 11 wherein the space has a height of approximately between three inches and eighteen inches, and a width of approximately between one foot and three feet.

15. An air ventilation arrangement for a motor vehicle including an air vent, the arrangement comprising:
a camera configured to capture images of a human hand in a space in proximity to the air vent;
an actuator configured to move baffles of the air vent to thereby change a direction of air flow out of the air vent; and
an electronic processor communicatively coupled to the camera and to the actuator, the electronic processor being configured to:
analyze the images captured by the camera to thereby determine a location of the human hand in three-dimensional space; and
control the actuator to move the baffles such that the air flows out of the air vent in a direction toward the determined location of the human hand.

16. The arrangement of claim 15 wherein the space is enclosed by imaginary boundaries.

17. The arrangement of claim 16 wherein the space is crescent-shaped when viewed in a vertical direction.

18. The arrangement of claim 16 wherein the electronic processor is configured to not control the actuator to move the baffles when the human hand is outside the boundaries.

19. The arrangement of claim 16 wherein the space has a height of approximately between three inches and eighteen inches.

20. The arrangement of claim 19 wherein the space has a width of approximately between one foot and three feet.
